(19) United States
(12) Patent Application Publication
(10) Pub. No.: US 2025/0350814 A1
(43) Pub. Date: Nov. 13, 2025

(54) SELF-HEALING MULTIMEDIA EMPLOYMENT GENERATIVE AI SYSTEM

(71) Applicant: PEOZZLE Corporation, Plymouth, MN (US)

(72) Inventor: Edward Chavan, Plymouth, MN (US)

(73) Assignee: PEOZZLE Corporation, Plymouth, MN (US)

(21) Appl. No.: 18/983,069

(22) Filed: Dec. 16, 2024

Related U.S. Application Data
(60) Provisional application No. 63/610,984, filed on Dec. 15, 2023.

(51) Int. Cl. H04N 21/85

(52) U.S. Cl. CPC H04N 21/85

(57) ABSTRACT

A self-healing multi-media employment content generative AI system computing device implemented method includes: generating self-healing multi-media employment content using AI, which includes special purpose software components of the self-healing multi-media employment content generative AI system; and generating self-healing multi-media employment content using AI, which includes special purpose software components of a self-healing multi-media employment content quality check and bias check AI system.

### CROSS REFERENCE TO RELATED APPLICATIONS

This Non-Provisional Patent Application claims the benefit of the filing date of U.S. Provisional Patent Application Ser. No. 63/610,984, filed Dec. 15, 2023, entitled “SELF-HEALING MULTIMEDIA EMPLOYMENT GENERATIVE AI SYSTEM,” the entire teachings of which are incorporated herein by reference.

This application is related to U.S. patent application Ser. No. 15/014,000, filed Feb. 2, 2016, entitled “MULTIMEDIA HUMAN RESOURCE DISTRIBUTION SYSTEM,” having Attorney Docket No. P1476.101.103, now U.S. Pat. No. 11,107,039, U.S. patent application Ser. No. 15/013,998, filed Feb. 2, 2016, entitled “MULTIMEDIA RESUME DISTRIBUTION SYSTEM,” having Attorney Docket No. P1476.101.102, now U.S. Pat. No. 11,107,038, both of which claim the benefit of the filing date of U.S. Provisional Patent Application Ser. No. 62/111,552, filed Feb. 3, 2015, entitled “MULTIMEDIA RESUME DISTRIBUTION SYSTEM,” having Attorney Docket No. P1476.101.101, which are herein incorporated by reference.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a diagram of an example of a self-healing multi-media employment content generative AI system.

FIG. 2 is a diagram illustrating an example of a self-healing multi-media employment content generative AI system architecture for building a self-healing multi-media employment content generative AI system.

FIG. 3 is a diagram of an example of a self-healing multi-media employment content generative AI solution architecture illustrating example roles that will be granted access privilege to a self-healing multi-media employment content generative AI system.

FIG. 4 is a diagram of an example of a self-healing multi-media employment content generative AI hardware architecture illustrating a hardware-based infrastructure, which includes special purpose hardware components of a self-healing multi-media employment content generative AI system.

FIG. 5 is a diagram of an example of a self-healing multi-media employment content generative AI software architecture illustrating a software application solution, which includes special purpose Software components of a self-healing multi-media employment content generative AI system.

FIG. 6 is a diagram of an example of a self-healing multi-media employment content generative AI hardware core illustrating a hardware-based infrastructure, which includes special purpose hardware components of a self-healing multi-media employment content generative AI system.

FIG. 7 is a diagram of an example of a self-healing multi-media employment content generative AI software core illustrating a software application solution, which includes special purpose Software components of a self-healing multi-media employment content generative AI system.

FIG. 8 is a diagram of an example of a self-healing multi-media employment content generative AI software core illustrating a software application solution, which includes special purpose Software components of a self-healing multi-media employment content quality check and bias check AI system.

FIG. 9 is a diagram of a method of a software core to generate self-healing multi-media employment content using AI, which includes special purpose Software components of a self-healing multi-media employment content generative AI system and self-healing multi-media employment content quality check and bias check AI system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In the following Detailed Description, reference is made to the accompanying drawings, which form a part hereof, and in which is shown by way of illustration specific embodiments in which the invention may be practiced. Because components of embodiments can be positioned in a number of different orientations, directional terminology is used for purposes of illustration and is in no way limiting. It is to be understood that other embodiments may be utilized and structural or logical changes may be made without departing from the scope of the present invention.

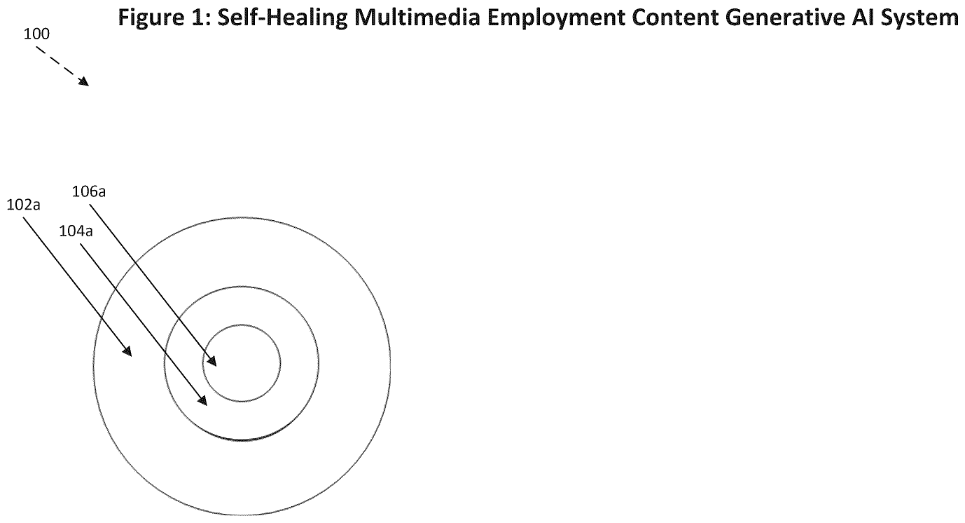

FIG. 1 illustrates an example of a self-healing multi-media employment content generative AI system. A self-healing multi-media employment content generative AI system 100 includes: multi-media employment content generative AI client systems 102a; multi-media employment content generative AI server systems 104a; multi-media employment content generative AI core systems 106a.

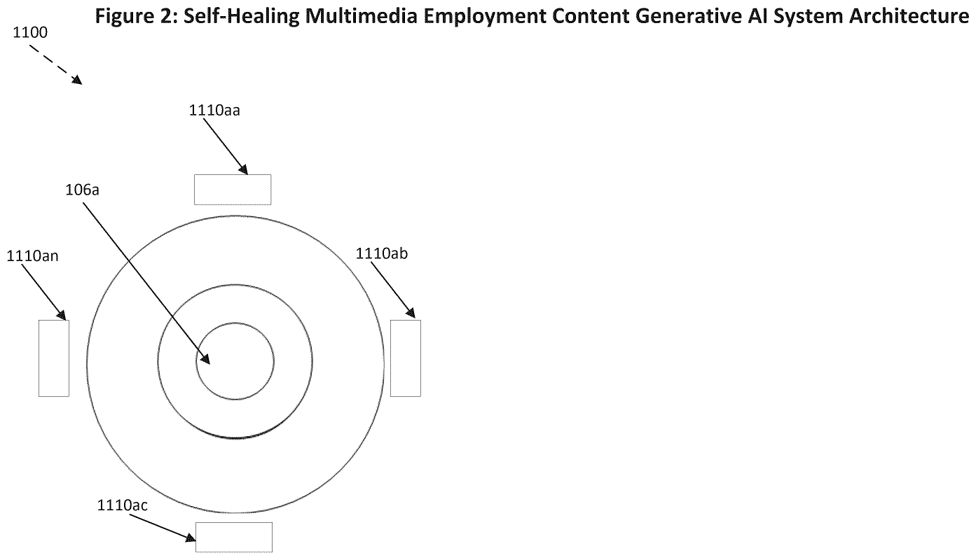

FIG. 2 illustrates an example of a self-healing multi-media employment content generative AI system architecture. Self-healing multi-media employment content generative AI system architecture 1100 includes: a group of self-healing multi-media employment content generative AI core systems 106a, a group of hiring teams 1110aa, a group of job seekers 1110ab, a group of third-party service providers 1110ac, and a group of staffing teams 1110an.

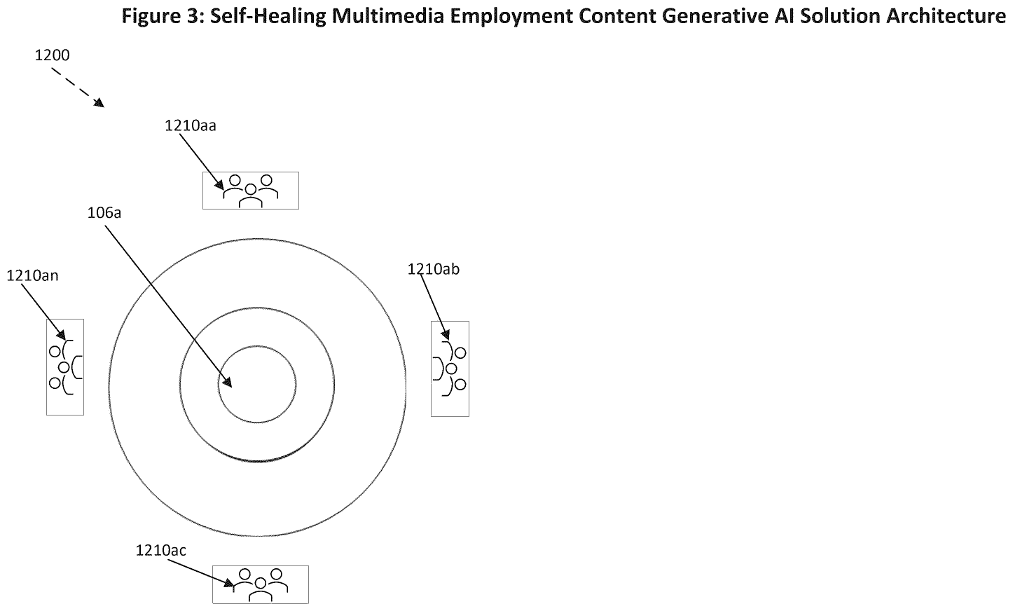

FIG. 3 illustrates an example of a self-healing multi-media employment content generative AI solution architecture 1200 illustrating example roles that will be granted access privilege to a self-healing multi-media employment content generative AI system. Roles that will be granted access privilege to the self-healing multi-media employment content generative AI system include an example hiring teams 1210aa including a hiring screener role, a hiring manager role, and a hiring interviewer role. In some scenarios, a single user may play more than one role at any time.

FIG. 3 illustrates group of job seekers (such as, candidates, students, interns, and volunteers, etc.,) 1210ab. There can be any number of job seekers. Example job seekers include legal assistant, software consultant, office administrator, and any other suitable job candidates. In some scenarios, a single user may play more than one role at any time.

FIG. 3 illustrates group of third-party service provider roles 1210ac. There can be any number of third-party service provider roles. Example third-party service provider roles 1210ac include career boards, social media channels, credential verifiers, candidate backpack services, sub-contracting service provider, personality test provider, drug test provider, aptitude test provider, background check provider, and any other suitable third-party service provider role. In some scenarios, a single user may play more than one role at any time.

FIG. 3 illustrates staffing team roles 1210an including a group of staffing recruiter roles, a group of staffing account manager roles, a group of staffing manager roles, a group of human resources recruiter roles, a group of human resources manager roles, a group of placement officer roles, a group of placement manager roles, a group of placement director roles, a group of volunteer coordinator roles, and a group of volunteer coordinator manager roles. There can be any number of staffing recruiter roles, any number of staffing account manager roles, any number of staffing manager roles, any number of human resources recruiter roles, any number of human resources manager roles, any number of placement officer roles, any number of placement manager roles, any number of placement director roles, any number of volunteer coordinator roles, and any number of volunteer coordinator manager roles. In some scenarios, a single user may play more than one role at any time.

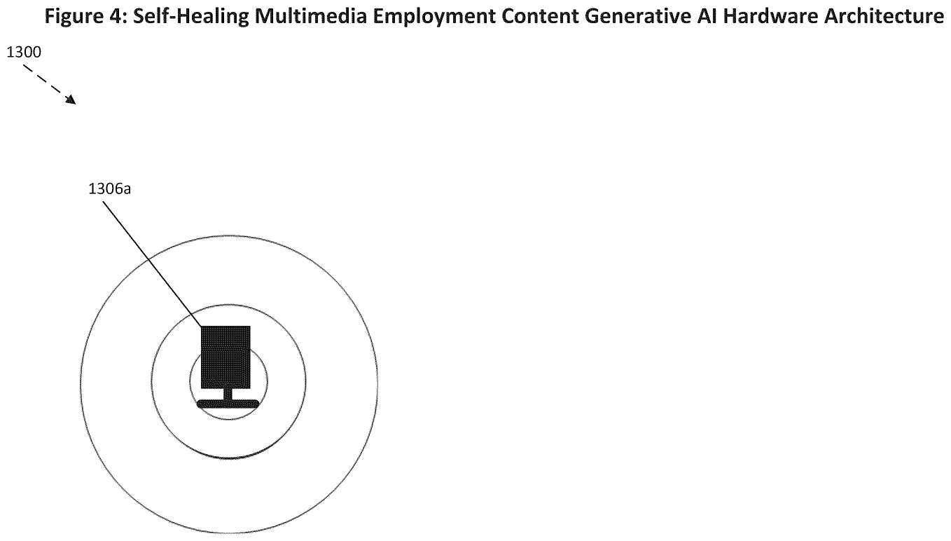

FIG. 4 illustrates an example of a self-healing multi-media employment content generative AI hardware architecture 1300 illustrating a hardware-based infrastructure solution, which includes special purpose hardware components of a self-healing multi-media employment content generative AI system. A special purpose hardware component system that can be employed in an operating environment and used to host or run a computer application implementing methods of this disclosure (such as method 9000), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, and text. Computing device can be configured to run an operating system Software program and one or more computer Software applications, which make up a system platform. A computer Software application configured to execute on the computing device is typically provided as a set of instructions written in a programming language, implementing methods of this disclosure, such as method 9000. A computer application configured to execute on the computing device includes at least one computing process (or computing task), which is an executing program. Each computing process provides the computing resources to execute the program. Self-healing multi-media employment content generative AI hardware architecture 1300 includes a group of self-healing multi-media employment content generative AI core appliances 1306a.

Group of self-healing multi-media employment content generative AI core appliances 1306a comprises: a group of self-healing multi-media employment content generative AI core appliances; a group of self-healing multi-media employment content generative AI security core appliances; a group of self-healing multi-media employment content generative AI video content core appliances; a group of self-healing multi-media employment content generative AI audio content core appliances; a group of self-healing multi-media employment content generative AI graphics content core appliances; a group of self-healing multi-media employment content generative AI text content core appliances; a group of self-healing multi-media employment content quality check and bias check AI relationship core appliances; a group of self-healing multi-media employment content quality check and bias check AI security core appliances; a group of self-healing multi-media employment content quality check and bias check AI video content core appliances; a group of self-healing multi-media employment content quality check and bias check AI audio content core appliances; a group of self-healing multi-media employment content quality check and bias check AI graphics content core appliances; a group of self-healing multi-media employment content quality check and bias check AI text content core appliances. Example self-healing multi-media employment content generative AI core appliances 1306a can include a suitable combination of suitable computer servers, such as commodity grade servers, mid-range servers, high end servers, high availability servers, cloud based servers, and data center based servers, in-house servers, and other suitable servers. employment core appliances can also be housed in a suitable combination of cloud service providers, data center providers, and in-house servers. self-healing multi-media employment content generative AI core appliances 1306a can provide data backup, data archival, data restore capabilities, physical security, network security, and other suitable server services.

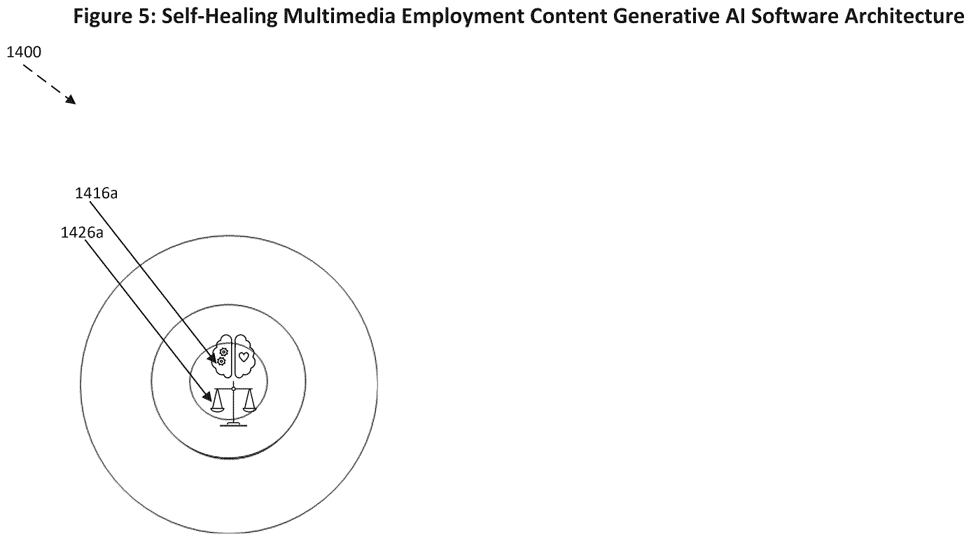

FIG. 5 is a diagram of an example of a self-healing multi-media employment content generative AI software architecture illustrating a software application solution, which includes special purpose Software components of a self-healing multi-media employment content generative AI system.

FIG. 5 illustrates an example self-healing multi-media employment content generative AI software architecture 1400 illustrating a software application Solution, which includes a special purpose software components of a self-healing multi-media employment content generative AI system. Self-healing multi-media employment content generative AI software architecture 1400 executes on self-healing multi-media employment content generative AI hardware architecture 1300. Self-healing multi-media employment content generative AI software architecture 1400 includes a group of self-healing multi-media employment content generative AI core applications 1416a, and a group of self-healing multi-media employment quality check and bias check generative AI core applications 1426a.

Group of self-healing multi-media employment content generative AI core applications 1416a includes integration instructions for controlling communications and represents special purpose media delivery Software applications, which includes delivery instructions for optimal data transfer and protection of data, and comprises: a group of trainable self-healing multi-media employment content generative AI core application Software components (which executes on a group of self-healing multi-media employment content generative AI core appliances 1306a respectively); a group of trained self-healing multi-media employment content generative AI relationship core application Software components (which executes on a group of self-healing multi-media employment content generative AI relationship core appliances 1306a respectively); a group of trained self-healing multi-media employment content generative AI security core application Software components (which executes on a group of self-healing multi-media employment content generative AI security core appliances 1306a respectively); a group of trained self-healing multi-media employment content generative AI video content core application software components (which executes on a group of self-healing multi-media employment content generative AI video content core appliances 1306a respectively); a group of trained self-healing multi-media employment content generative AI audio content core application Software components (which executes on a group of self-healing multi-media employment content generative AI audio content core appliances 1306a respectively); a group of trained self-healing multi-media employment content generative AI graphics content core application Software components (which executes on a group of self-healing multi-media employment content generative AI content core appliances 1306a respectively); a group of trained self-healing multi-media employment content generative AI text content core application software components (which executes on a group of self-healing multi-media employment content generative AI text content core appliances 1306a respectively); a group of trained self-healing multi-media employment content generative AI Virtual Reality content core application software components (which executes on a group of self-healing multi-media employment content generative AI Virtual Reality content core appliances 1306a respectively); and a group of trained self-healing multi-media employment content generative AI Augmented Reality content core application software components (which executes on a group of self-healing multi-media employment content generative AI Augmented Reality content core appliances 1306a respectively).

Group of self-healing multi-media employment content generative AI core applications 1416a includes integration instructions for controlling communications and represents special purpose media delivery Software applications, which includes delivery instructions for optimal data transfer and protection of data, and comprises: a group of trainable self-healing multi-media employment content quality check and bias check AI core application Software components (which executes on a group of self-healing multi-media employment content generative AI core appliances 1306a respectively); a group of trained self-healing multi-media employment content quality check and bias check AI relationship core application Software components (which executes on a group of self-healing multi-media employment content generative AI relationship core appliances 1306a respectively); a group of trained self-healing multi-media employment content quality check and bias check AI security core application Software components (which executes on a group of self-healing multi-media employment content generative AI security core appliances 1306a respectively); a group of trained self-healing multi-media employment content quality check and bias check AI video content core application software components (which executes on a group of self-healing multi-media employment content generative AI video content core appliances 1306a respectively); a group of trained self-healing multi-media employment content quality check and bias check AI audio content core application Software components (which executes on a group of self-healing multi-media employment content quality check and bias check AI audio content core appliances 1306a respectively); a group of trained self-healing multi-media employment content quality check and bias check AI graphics content core application Software components (which executes on a group of self-healing multi-media employment content generative AI content core appliances 1306a respectively); a group of trained self-healing multi-media employment content quality check and bias check AI text content core application software components (which executes on a group of self-healing multi-media employment content generative AI text content core appliances 1306a respectively); a group of trained self-healing multi-media employment content quality check and bias check AI Virtual Reality content core application software components (which executes on a group of self-healing multi-media employment content generative AI Virtual Reality content core appliances 1306a respectively); and a group of trained self-healing multi-media employment content quality check and bias check AI Augmented Reality content core application software components (which executes on a group of self-healing multi-media employment content generative AI Augmented Reality content core appliances 1306a respectively).

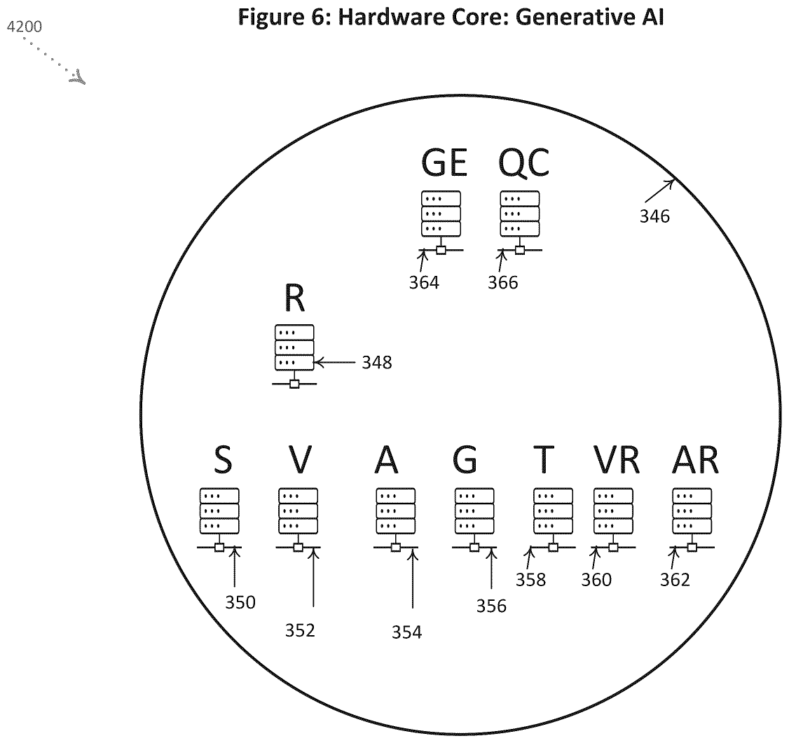

FIG. 6 is a diagram of an example of a self-healing multi-media employment content generative AI hardware core 4200 illustrating a hardware-based infrastructure solution, which includes special purpose hardware components of a self-healing multi-media employment content generative AI system.

Group of self-healing multi-media employment content generative AI core appliances 346 comprises: a group of self-healing multi-media employment content generative AI relationship core appliances 348; a group of self-healing multi-media employment content generative AI security core appliances 350; a group of self-healing multi-media employment content generative AI video content core appliances 352; a group of self-healing multi-media employment content generative AI audio content core appliances 354; a group of self-healing multi-media employment content generative AI graphics content core appliances 356; a group of self-healing multi-media employment content generative AI text content core appliances 358; a group of self-healing multi-media employment content generative AI virtual reality content core appliances 360; a group of self-healing multi-media employment content generative AI augmented reality content core appliances 362; a group of trainable generative AI content core appliances 364; a group of trainable quality check and bias check content core appliances 366. Example staffing core appliances 346 can include a suitable combination of suitable computer Servers. Such as commodity grade servers, mid-range servers, high end servers, high availability servers, cloud based servers, and data center based servers, in-house server, and other suitable servers. Staffing core appliances 346 can also be housed in a suitable combination of cloud service providers, data center providers, and in-house servers. Staffing core appliances 346 can provide data backup, data archival, data restore capabilities, physical security, network security, and other suitable server services.

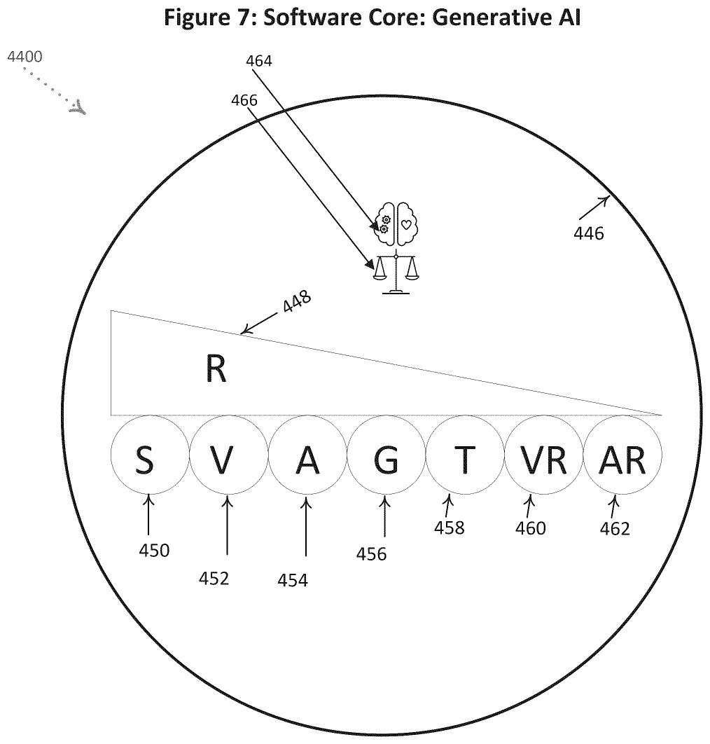

FIG. 7 is a diagram of an example of a self-healing multi-media employment content generative AI software core 4400 illustrating a software application solution, which includes special purpose Software components of a self-healing multi-media employment content generative AI system.

Group of self-healing multi-media employment content generative AI core applications 446 includes integration instructions for controlling communications and represents special purpose media delivery Software applications, which includes delivery instructions for optimal data transfer and protection of data, and comprises: a group of trainable self-healing multi-media employment content generative AI core application Software components 464 (which executes on a group of self-healing multi-media employment content generative AI core appliances 364 respectively); a group of trained self-healing multi-media employment content generative AI relationship core application Software components 448 (which executes on a group of self-healing multi-media employment content generative AI relationship core appliances 348); a group of trained self-healing multi-media employment content generative AI security core application Software components 450 (which executes on a group of self-healing multi-media employment content generative AI security core appliances 350); a group of trained self-healing multi-media employment content generative AI core applications video content software components 452 (which executes on a group of self-healing multi-media employment content generative AI video content core appliances 352); a group of trained self-healing multi-media employment content generative AI core applications audio content Software components 454 (which executes on a group of self-healing multi-media employment content generative AI audio content core appliances 354); a group of trained self-healing multi-media employment content generative AI core applications graphics content Software components 456 (which executes on a group of self-healing multi-media employment content generative AI graphics content core appliances 356); and a group of trained self-healing multi-media employment content generative AI core applications text content software components 458 (which executes on a group of self-healing multi-media employment content generative AI text content core appliances 358); and a group of trained self-healing multi-media employment content generative AI core applications virtual reality content software components 460 (which executes on a group of self-healing multi-media employment content generative AI virtual reality content core appliances 360); and a group of trained self-healing multi-media employment content generative AI core applications augmented reality content software components 462 (which executes on a self-healing multi-media employment content generative AI group of augmented reality content core appliances 362).

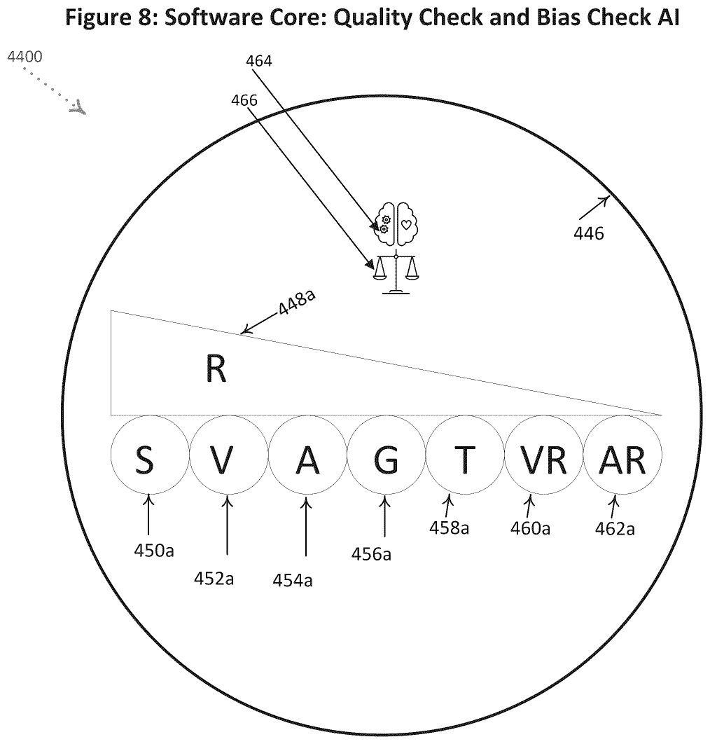

FIG. 8 is a diagram of an example of a self-healing multi-media employment content generative AI software core 4400 illustrating a software application solution, which includes special purpose Software components of a self-healing multi-media employment content quality check and bias check AI system.

Group of self-healing multi-media employment content generative AI core applications 446 includes integration instructions for controlling communications and represents special purpose media delivery Software applications, which includes delivery instructions for optimal data transfer and protection of data, and comprises: a group of trainable self-healing multi-media employment content quality check and bias check AI core application Software components 466 (which executes on a group of self-healing multi-media employment content generative AI core appliances 366 respectively); a group of trained self-healing multi-media employment content check and bias check AI relationship core application Software components 448a (which executes on a group of self-healing multi-media employment content generative AI relationship core appliances 348); a group of trained self-healing multi-media employment content quality check and bias check AI security core application Software components 450a (which executes on a group of self-healing multi-media employment content generative AI security core appliances 350); a group of trained self-healing multi-media employment content quality check and bias check AI core applications video content software components 452a (which executes on a group of self-healing multi-media employment content generative AI video content core appliances 352); a group of trained self-healing multi-media employment content quality check and bias check AI core applications audio content Software components 454a (which executes on a group of self-healing multi-media employment content quality check and bias check AI audio content core appliances 354); a group of trained self-healing multi-media employment content quality check and bias check AI core applications graphics content Software components 456a (which executes on a group of self-healing multi-media employment content generative AI graphics content core appliances 356); and a group of trained self-healing multi-media employment content quality check and bias check AI core applications text content software components 458a (which executes on a group of self-healing multi-media employment content generative AI text content core appliances 358); and a group of trained self-healing multi-media employment content quality check and bias check AI core applications virtual reality content software components 460a (which executes on a group of self-healing multi-media employment content generative AI virtual reality content core appliances 360); and a group of trained self-healing multi-media employment content quality check and bias check AI core applications augmented reality content software components 462a (which executes on a self-healing multi-media employment content generative AI group of augmented reality content core appliances 362).

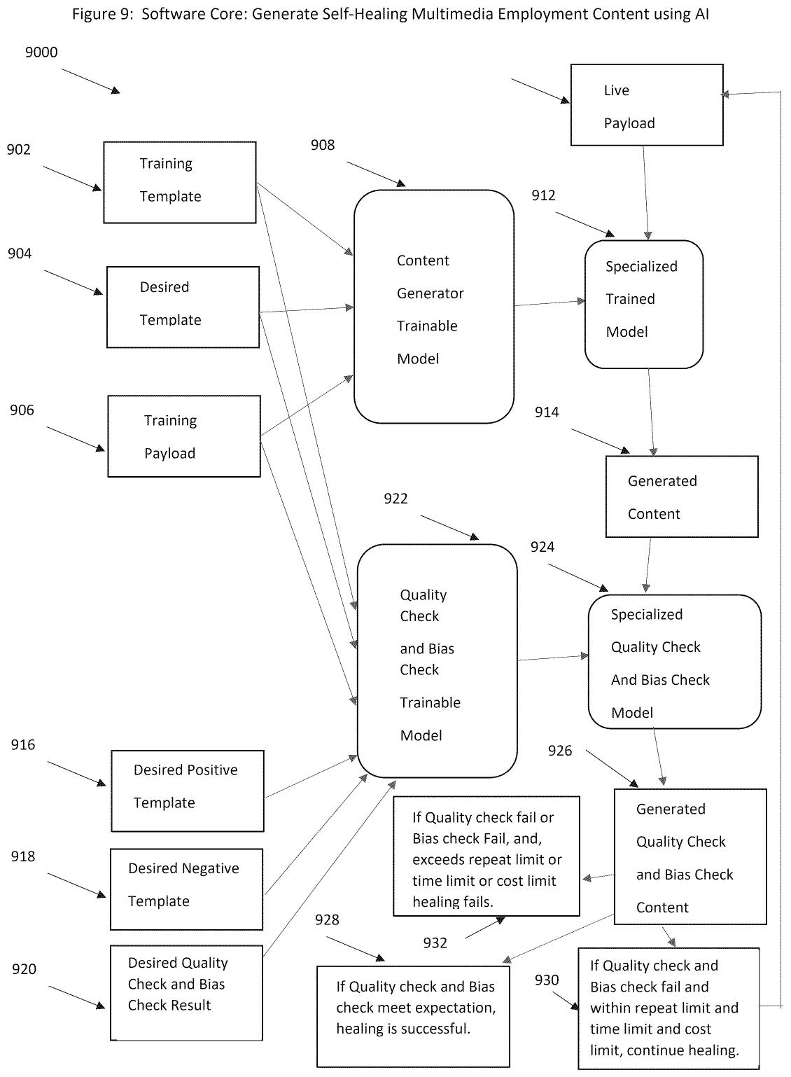

FIG. 9 is a diagram of a method 9000 of a software core to generate self-healing multi-media employment content using AI, which includes special purpose Software components of a self-healing multi-media employment content generative AI system and self-healing multi-media employment content quality check and bias check AI system.

A large set of training template 902 is used to train the content generator trainable model 908, which is a special purpose machine learning model, such as Large Language Model. This allows the model to learn the structure and the relationship of a combination of contents, such as text content, audio content, video content, graphics content, virtual reality content, and augmented reality content, etc.,

Specialized trained model 912 can generate content, based on a set of prompts. The prompts can be natural language and/or pre-specified.

Desired template 904 is used to feed a Specialized trained model 912 to generate employment content in a specific format, such as a graphical job description.

Training payload 906 is used to feed a Specialized trained model 912 to embed specific set of information within the desired template 904, such as a graphical job description for a given job position.

Live payload 910 is used to feed Specialized trained model 912 during live processing of data.

Generated content 914 is generated by the Specialized trained model 912, based on the live payload 910 or training payload 906.

Desired positive template 916 is used to train the quality check and bias check trainable model 922 to learn positive content that is expected to be generated by the Specialized trained model 912. This is used for testing positive cases.

Desired negative template 918 is used to train the quality check and bias check trainable model 922 to learn negative content that is expected to be generated by the Specialized trained model 912. This is used for testing negative cases.

Desired Quality Check Bias Check Result 920 defines the expected result, such as pass or fail for the purpose of training the Quality Check and Bias Check Trainable model 922.

Specialized Quality Check and Bias Check model 924 is a trained model, which can generate Quality Check and Bias Check Content 926 by processing the Generated content 914 that is generated by the Specialized Trained Model 912.

When the Quality Check and Bias Check meet the expectation 928, healing of the generated content 914 is considered as successful. Generated Content 914 is published for consumption.

When the Quality Check fails or Bias Check fails, and upper limit of healing repeat count is reached or upper healing time limit is reached or upper cost limit to generate the content 914 is reached, then healing of the generated content is considered as failure. Generated Content 914 is not published for consumption. A failure message is published.

When the Quality fails or Bias Check fails, and upper limit of healing repeat count is not reached and upper healing time limit is not reached and upper cost limit to generate the content 914 is not reached, then healing of the generated content can continue by feeding the live payload 910 to be processed by Specialized Trained Model 912.

The outcome of method 9000 is that the generated content 914 related to employment is healed before it is published for consumption.

It is to be understood that the features of the various exemplary embodiments described herein may be combined with each other, unless specifically noted otherwise. Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A self-healing multi-media employment content generative AI system computing device implemented method comprising:
generating self-healing multi-media employment content using AI, which includes special purpose software components of the self-healing multi-media employment content generative AI system; and
generating self-healing multi-media employment content using AI, which includes special purpose software components of a self-healing multi-media employment content quality check and bias check AI system.
